(19) United States
(12) Patent Application Publication
(10) Pub. No.: US 2022/0315312 A1
(43) Pub. Date: Oct. 6, 2022

(54) FOOD PREPARATION METHOD

(71) Applicant: Cuisine Solutions, Inc., Sterling, VA (US)

(72) Inventors: Julien Vanderlynden, Alexandria, VA (US); Jeffrey Sklaney, Sterling, VA (US)

(21) Appl. No.: 17/218,447

(22) Filed: Mar. 31, 2021

(51) Int. Cl. B65D 81/34; A23L 5/10

(52) U.S. Cl. CPC B65D 81/3415; A23L 5/13

(57) ABSTRACT

A method of preparing a food item, including the steps of: placing at least one uncooked protein element and at least one cooked bread element into a package without sealing the at least one cooked bread element to any other element in the package, sealing the package without sealing the at least one cooked bread element to any other element in the package, and forming a food item by cooking the uncooked protein element in the sealed package without sealing the at least one cooked bread element to any other element in the package.

### CROSS-REFERENCE TO RELATED APPLICATION

This application claims priority under 35 USC § 119(e) from U.S. provisional patent application Ser. No. 63/003,505 filed on Apr. 1, 2020, the disclosure of which is incorporated herein by reference in its entirety.

### BACKGROUND OF THE INVENTION

The present invention relates to methods of preparing food items, and more particularly, to methods of food preparation and packaging of food items.

Currently, there is a market for pre-cooked, packaged food. For example, busy people, restaurants, and the military desire the convenience provided by such products. Typically, such food items are cooked and then packaged, usually being either chilled or frozen for travel to their ultimate destination. As an example, pot roast, turkey and gravy, or meatloaf can be cooked and then packaged prior to chilling for transport to a grocery store, where the food item is stored and displayed in a refrigerated case.

These examples are typically prepared using high heat cooking methods, such as baking in an oven. Other examples of high heat cooking methods include grilling or broiling. These high heat methods often result in food that is unevenly cooked and may lose some natural juices. While such results may be desirable for foods such as a medium rare steak, for many foods, a more even cooking is desirable. In addition, subsequent to cooking and prior to packaging, the opportunity exists for the cooked food to encounter bacteria, thereby potentially contaminating the food, and at least limiting the shelf life of the food.

Further, the ability to provide a high quality, consistent product often relies on the culinary skill of the end user. Without proper training, consistent desired results are difficult to achieve.

### SUMMARY OF EMBODIMENTS OF THE INVENTION

Accordingly, it is an aspect of the present invention to provide a process via which a consistent, high-quality food product can be created without significant culinary skill on the part of an end user.

The foregoing and/or other aspects of the present invention are achieved by providing a method of preparing a food item, comprising the steps of: placing at least one uncooked protein element and at least one cooked bread element into a package without sealing the at least one cooked bread element to any other element in the package, sealing the package without sealing the at least one cooked bread element to any other element in the package, and forming a food item by cooking the uncooked protein element in the sealed package without sealing the at least one cooked bread element to any other element in the package.

The foregoing and/or other aspects of the present invention are also achieved by providing a method of preparing a food item, comprising the steps of: placing uncooked ground meat and two cooked portions of a bun in a package, without sealing the two cooked portions of the bun to anything in the package, vacuum sealing the package without sealing the two cooked portions of the bun to anything in the package, and forming a food item by cooking the ground meat in the sealed package without sealing the two cooked portions of the bun to anything in the package.

The foregoing and/or other aspects of the present invention are also achieved by providing a method of preparing a food item, comprising the steps of: placing at least one uncooked protein element and at least one frozen, uncooked dough element into a package, sealing the package, and forming a food item by cooking the uncooked protein element and the at least one frozen, uncooked dough element in the sealed package.

Additional and/or other aspects and advantages of the present invention will be set forth in the description that follows, or will be apparent from the description, or may be learned by practice of the invention.

### BRIEF DESCRIPTION OF THE DRAWINGS

Aspects and advantages of embodiments of the invention will be more readily appreciated from the following detailed description, taken in conjunction with the accompanying drawings, of which:

FIG. 1 is a flow chart of a method in accordance with an embodiment of the present invention;

FIGS. 2-6 illustrate steps of the method of FIGS. 1, 7, and 8;

FIG. 7 is a flow chart in accordance with another embodiment of the present invention; and

FIG. 8 is a flow chart in accordance with another embodiment of the present invention.

### DETAILED DESCRIPTION

Reference will now be made in detail to embodiments of the present invention, which are illustrated in the accompanying drawings, wherein like reference numerals refer to like elements throughout. The embodiments described herein exemplify, but do not limit, the present invention by referring to the drawings.

The embodiments are not intended to be mutually exclusive so that the features of one embodiment can be combined with other embodiments as long as they do not contradict each other.

It will be understood by one skilled in the art that this disclosure is not limited in its application to the details of construction and the arrangement of components or steps set forth in the following description or illustrated in the drawings. The embodiments herein are capable of other embodiments, and capable of being practiced or carried out in various ways. Phraseology and terminology used herein is for the purpose of description and should not be regarded as limiting. The use of “including,” “comprising,” or “having” and variations thereof herein is meant to encompass the items listed thereafter and equivalents thereof as well as potentially encompassing additional items.

Unless limited otherwise, terms such as “up,” “down,” “bottom,” “top,” “front,” “rear,” “upper,” “lower,” “upwardly,” “downwardly,” and other orientational descriptors are intended to facilitate the description of the exemplary embodiments of the present invention, and are not intended to limit the structure or steps of the exemplary embodiments of the present invention to any particular position or orientation. Terms of degree, such as “substantially” or “approximately” are understood by those skilled in the art to refer to reasonable ranges around and including the given value and ranges outside the given value, for example, general tolerances associated with manufacturing, assembly, and use of the embodiments.

Although many people can be involved in the described processes to produce and use the described food items, for brevity, they are collectively described as a single user. One skilled in the art will appreciate however, that embodiments of the present invention are not limited to a single user.

Sous-vide cooking is a method of sealing food in an airtight container (generally, a plastic bag) and cooking the food in the sealed container in a water bath with a well-regulated temperature. In sous-vide cooking processes, the inside and outside of the food item cook to substantially the same level and the food maintains its natural juices.

Pasteurization is a process of heating a food to a certain temperature (generally around 70° C. (−160° F.), for a period of time, and then cooling the item subsequent to removing it from the heat. The goal of pasteurization is to kill most of the harmful germs (so that they are unlikely to cause illness) without major chemical alteration of the food. In contrast, cooking causes a chemical alteration of the food.

Softening a food item, such as cheese, is also contrasted with cooking, because when the cheese softens, while it undergoes at least a partial physical change of the state of matter, it is not undergoing a chemical alteration. It is noted, however, that cheese could be further heated and browned, but that browning would be a chemical alteration, and thus, cooking.

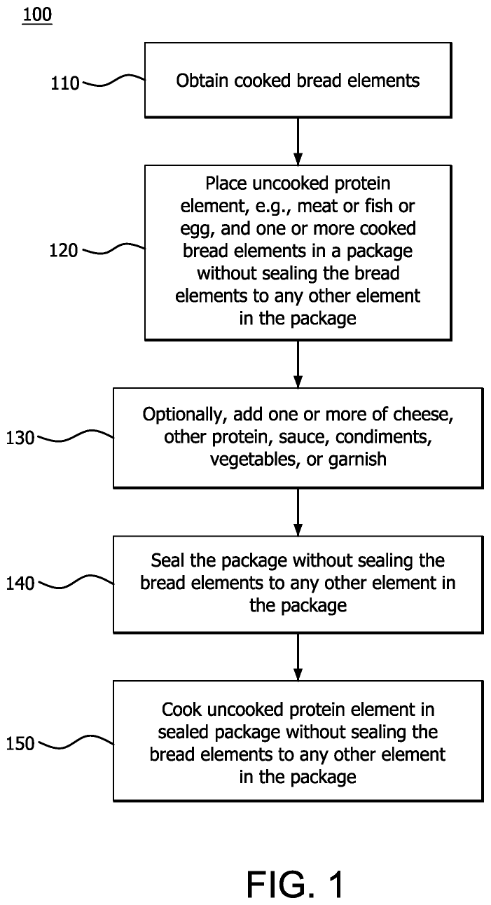

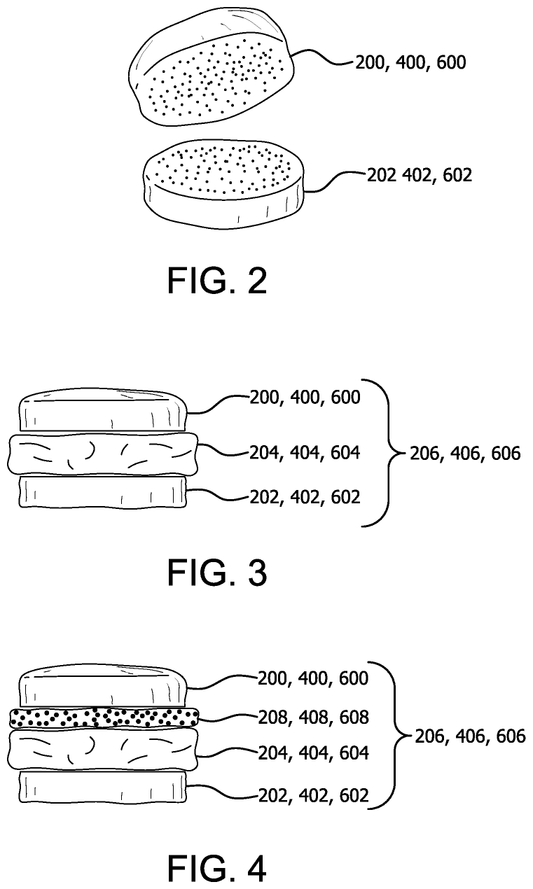

FIGS. 1-6 illustrate a method 100 of preparing a food item. In operation 110, as shown in FIG. 2, a user obtains at least one bread element. One way to obtain a bread element is cooking the bread element. The bread element can be a slice of bread, or a bun, or another type of bread element. If the bread element is a bun or English muffin, for example, the user preferably splits or cuts the bun or English muffin into two pieces to from two cooked bread elements 200, 202, for example, a bun top and a bun bottom. If the user cooks a loaf of bread, the user preferably slices at least two pieces of bread from the loaf to form at least two cooked bread elements 200, 202. These bread elements can be fully cooked bread elements, but optionally, the user can toast fully cooked bread elements to form cooked bread elements 200, 202. As another option, the user can par-cook the bread. For purposes of this application, par-cooking bread means cooking bread so that it is fully structurally formed, but not browned, or at least not completely browned.

It will be understood, however, that cooked bread items can also be purchased or otherwise obtained without departing from the scope of the present invention.

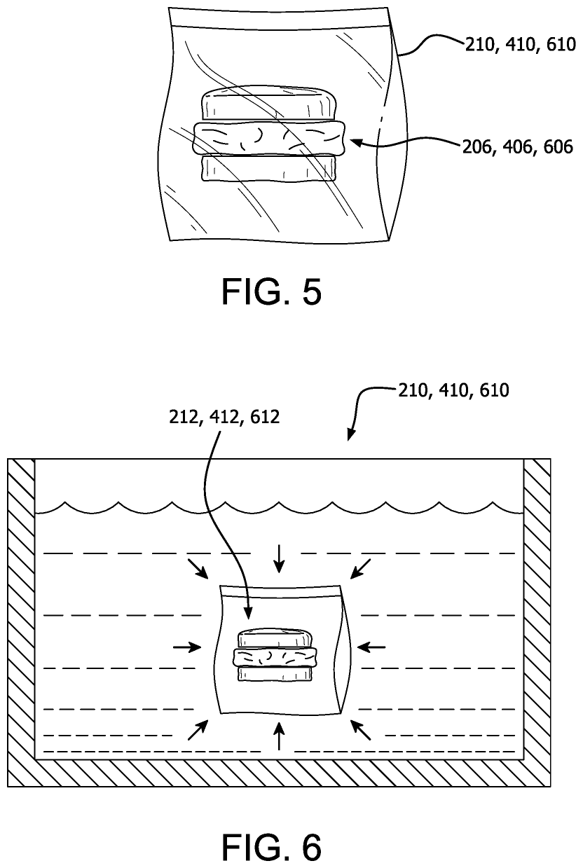

In operation 120, as shown in FIG. 5, a user places an uncooked or raw protein element 204, for example, meat or fish 204, and at least one fully cooked bread element in a package 210 without sealing the at least one fully cooked bread element 202 to any other element in the package 210. In other words, the cooked bread element 202 is not sealed to another bread element 200 to encapsulate or encase the uncooked protein element 204. Nor does the uncooked protein element 204 encapsulate or encase the cooked bread element 202. Preferably, the user places the uncooked or raw protein element 204 between two cooked bread elements 200, 202 without sealing the bread elements to any other elements in the package 210, as shown in FIG. 3, to form a food combination 206. According to one embodiment, the user forms the food combination 206 using only the uncooked meat or fish element 204 and at least one fully cooked bread element, e.g., bun bottom 202. As one option, the one or more fully cooked bread elements 200 and/or 202 can be frozen prior to commencing operation 120 and can be frozen when placing the uncooked or raw protein element 204 and the one or more fully cooked frozen bread element 200 and/or 202. in the package.

According to one embodiment, the uncooked or raw protein element is egg or egg white. According to yet another embodiment, the egg or egg white is mixed with cheese. To maintain a shape of the egg, egg white, or egg or egg white and cheese mixture (hereinafter egg/white/cheese mixture for brevity), the egg, egg white, or egg/white/cheese mixture is preferably quick frozen as a patty. This provides for easy handling of the egg, egg white, or egg/white/cheese mixture.

Although it is preferable to form the food combination 206 prior to placing the food combination 206 in the package 210, it will be understood that the food combination 206 can be assembled in the package 210 without departing from the present invention's scope.

According to another embodiment, optionally, in operation 130 (see FIG. 4), the user places one or more pieces of other food elements 208 in the package 210, for example, on the uncooked protein element 204 or on the cooked bread element 200, 202 to form the food combination 206. The one or more other food elements 208 can include, but is not limited to, one or more of seasoning (such as salt, pepper, or other seasoning), cheese, cooked onions, cooked bacon, cooked egg or egg white, sauces, condiments, tomato, or garnish.

The one or more other food elements 208 can also include another kind of uncooked protein placed in the package 210 by the user. For example, the user could place uncooked sausage (204) and uncooked ground beef (208) together, enshroud one of the uncooked meats with the other, or mix the uncooked sausage and uncooked ground beef. According to another example, the user could use uncooked egg, egg white, or egg/white/cheese mixture (204) and uncooked ground beef (208). According to yet another embodiment, the user could use uncooked turkey and uncooked duck or chicken. According to one embodiment, at least one of the uncooked turkey, duck, or chicken is ground.

According to one embodiment, the user places the one or more other food elements 208 on only one side of the uncooked protein 104. According to another embodiment, the user places the one or more other food elements 208 on more than one side of the uncooked protein 104.

In operation 140 (see FIG. 5), the user seals the package 210, preferably by vacuum sealing, without sealing the at least one cooked bread element 200, 202 to any other element in the package.

In operation 150 (FIG. 6), the user forms a food item 212 by fully cooking the uncooked meat or fish element 204 in the sealed package without sealing the at least one cooked bread element 200, 202 to any other element in the package. It will be understood that the if the one or more other food elements 208 includes another kind or more of the same kind of uncooked protein element, such as meat or fish 208, the food item 212 is formed by fully cooking the uncooked protein element 204 and the more or other kind of uncooked protein element 208. But it will also be understood that if the one or more other food elements 208 does not include an uncooked protein element, then the one or more other food elements 208 is not cooked during formation of the food item 212. For brevity and clarity, the one or more food elements 208 are generally omitted from the further description.

During operation 150, according to one embodiment, only the uncooked protein element 204, such as uncooked meat or fish 204, is undergoing the chemical alteration (cooking); and the bread elements 200, 202 are not cooked. In other words, the meat or fish 204 is cooked during operation 150 without cooking the bread elements 200, 202. According to another embodiment when the one or more bread elements 200, 202 are only par-cooked prior to being placed in the package 210, during operation 150, the uncooked protein element 204 is cooked and the one or more bread elements are browned or further browned.

Preferably, operation 150 is accomplished by sous vide cooking the protein element 204 (and in one embodiment, the one or more bread elements 200, 204) in the sealed package 210 while the protein element 204 is disposed between the two bread elements 200, 202. Such sous vide cooking can cook the meat or fish element 204 and also soften the optional cheese 208.

Subsequent to forming the fully cooked food item 212, the user can open the package 210 and remove and consume the fully cooked food item 212. Alternatively, the sealed package 210 can be cooled for later reheating and consumption.

After the cooking, and while still sealed in the package 210, the user can chill the food item 212. According to one embodiment, the user refrigerates the food item 212. According to another embodiment, the user freezes the food item 212. The user can then ship the chilled food item 212, for example, to a restaurant, a grocery store, or a home.

Subsequently, and while still sealed in the package 210, the user can re-heat the food item 212 using, for example, an oven, a microwave oven, or a water bath, for example, a pot of warm or hot water, or a sous-vide cooker.

Embodiments of uncooked protein elements 204 (and other uncooked protein elements 208) can include beef, lamb, chicken, turkey, pork, other uncooked pork products, such as pork sausage, or different kinds of fish or shellfish, or different preparations of uncooked fish or shellfish, such as breading with fully cooked bread items. It will be understood that when cooking such breaded fish or shellfish that the fish or shellfish would be cooked, but the fully cooked breading would not be cooked. In an embodiment in which par-cooked breading is employed for the fish or shellfish, the par-cooked breading would be browned or further browned during cooking. The uncooked protein element 204 can be ground meat, such as ground beef, pork, lamb, chicken, turkey, or venison, or a combination of different ground meats, e.g., non-pork sausage.

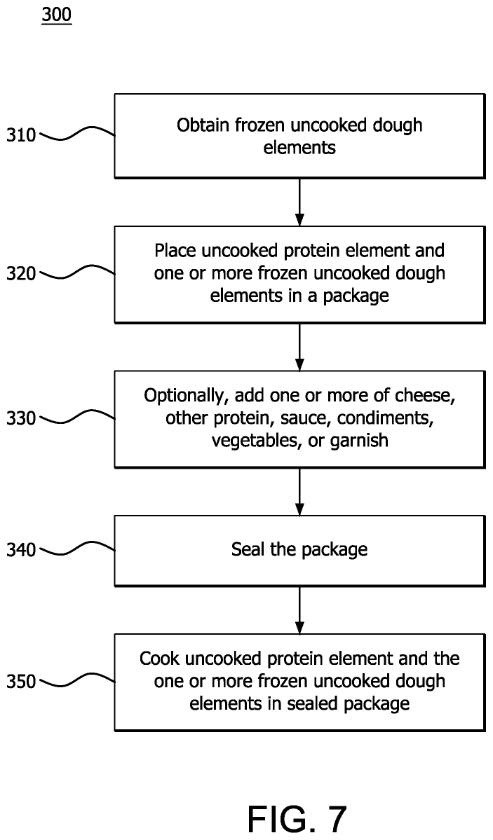

FIG. 7 illustrates a method 300 of preparing a food item. As shown in FIG. 2, in operation 310, a user obtains at least one frozen, uncooked dough element 400 and/or 402. As a non-limiting example, a user can make or purchase one or more uncooked dough elements and subsequently freeze the one or more uncooked dough elements. As another non-limiting example, a user can purchase one or more frozen, uncooked dough elements.

In operation 320, as shown in FIG. 5, a user places an uncooked or raw protein element 404, for example, meat or fish 404, and at least one frozen, uncooked dough element in a package 410. Preferably, the user places the uncooked or raw protein element 404 between two frozen, uncooked dough element 400, 402, as shown in FIG. 3, to form a food combination 406. According to one embodiment, the user forms the food combination 406 using only the uncooked meat or fish element 404 and only one frozen, uncooked dough element, e.g., bun bottom 402.

The uncooked or raw protein element 404 can be as previously described. Repetition of the previous description is omitted for brevity.

Although it is preferable to form the food combination 406 prior to placing the food combination 406 in the package 410, it will be understood that the food combination 406 can be assembled in the package 410 without departing from the present invention's scope.

According to another embodiment, optionally, in operation 330 (see FIG. 4), the user places one or more pieces of other food elements 408 in the package 410, for example, on the uncooked protein element 404 or on the frozen, uncooked dough elements 400, 404 to form the food combination 406. The one or more other food elements 408 can be as previously described. Repetition of the previous description is omitted for brevity.

In operation 340 (see FIG. 5), the user seals the package 410, preferably by vacuum sealing.

In operation 350 (FIG. 6), the user forms a food item 412 by fully cooking the uncooked protein element 404 and the frozen, uncooked dough element 402 in the sealed package. It will be understood that the if the one or more other food elements 408 includes another kind or more of the same kind of uncooked protein element as the uncooked protein element 404, such as meat or fish 408, the food item 412 is formed by fully cooking the uncooked protein element 404 and the more or other kind of uncooked protein element 408, as well as the frozen, uncooked dough element 402. But it will also be understood that if the one or more other food elements 408 does not include an uncooked protein element, then the one or more other food elements 408 is not cooked during formation of the food item 412. For brevity and clarity, the one or more food elements 408 are generally omitted from the further description.

Preferably, operation 350 is accomplished by sous vide cooking the protein element 404 and the one or more frozen, uncooked dough elements 400, 402 in the sealed package 410 while the protein element 404 is disposed between the two frozen, uncooked dough elements 400, 402 (which, once cooked, become bread elements). Such sous vide cooking can cook the meat or fish element 404 and frozen, uncooked dough elements 400, 402, and also soften optional cheese 408.

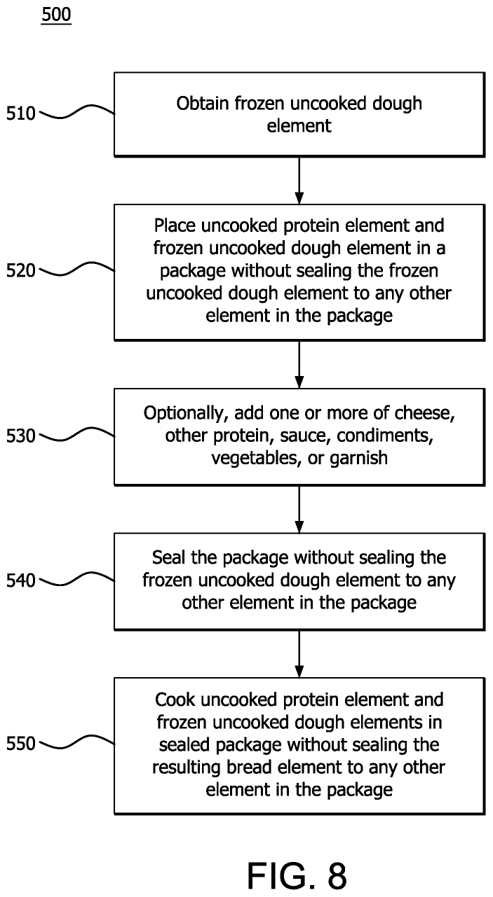

FIG. 8 illustrates a method 500 of preparing a food item. As shown in FIG. 2, in operation 510, a user obtains at least one frozen, uncooked dough element 600 and/or 602. As a non-limiting example, a user can make or purchase one or more uncooked dough elements and subsequently freeze the one or more uncooked dough elements. As another non-limiting example, a user can purchase one or more frozen, uncooked dough elements.

In operation 520, as shown in FIG. 5, a user places an uncooked or raw protein element 604, for example, meat or fish 204, and at least one frozen, uncooked dough element 602 in a package 610 without sealing the at least one frozen, uncooked dough element 602 to any other element in the package 610. In other words, the frozen, uncooked dough element 602 is not sealed to another bread element 600 to encapsulate or encase the uncooked protein element 604. Nor does the uncooked protein element 604 encapsulate or encase the frozen, uncooked dough element 602. Preferably, the user places the uncooked or raw protein element 604 between two frozen, uncooked dough elements 600, 602 without sealing the frozen, uncooked dough elements to any other elements in the package 610, as shown in FIG. 3, to form a food combination 606. According to one embodiment, the user forms the food combination 606 using only the uncooked meat or fish element 204 and the at least one frozen, uncooked dough element 602, e.g., bun bottom 602.

The uncooked or raw protein element 604 can be as previously described. Repetition of the previous description is omitted for brevity.

Although it is preferable to form the food combination 606 prior to placing the food combination 606 in the package 610, it will be understood that the food combination 606 can be assembled in the package 610 without departing from the present invention's scope.

According to another embodiment, optionally, in operation 530 (see FIG. 4), the user places one or more pieces of other food elements 608 in the package 610, for example, on the uncooked protein element 604 or on the frozen, uncooked dough elements 600, 602 to form the food combination 606. The one or more other food elements 608 can be as previously described. Repetition of the previous description is omitted for brevity.

In operation 540 (see FIG. 5), the user seals the package 610, preferably by vacuum sealing, without sealing the at least one frozen, uncooked dough element 600, 602 to any other element in the package.

In operation 650 (FIG. 6), the user forms a food item 612 by fully cooking the uncooked protein element 604 and the at least one frozen, uncooked dough element 600, 602 in the sealed package 610 without sealing the at least one frozen, uncooked dough element 600, 602 or the resulting bread elements 600, 602 to any other element in the package. It will be understood that the if the one or more other food elements 608 includes another kind or more of the same kind of uncooked protein element as the uncooked protein element 604, such as meat or fish 608, the food item 612 is formed by fully cooking the uncooked protein element 604 and the more or other kind of uncooked protein element 608, as well as the frozen, uncooked dough element 602. But it will also be understood that if the one or more other food elements 608 does not include an uncooked protein element, then the one or more other food elements 608 is not cooked during formation of the food item 612. For brevity and clarity, the one or more food elements 608 are generally omitted from the further description.

Preferably, operation 550 is accomplished by sous vide cooking the protein element 604 and the one or more frozen, uncooked dough elements 600, 602 in the sealed package 610 while the protein element 604 is disposed between the two between the two frozen, uncooked dough elements 400, 402 (which, once cooked, become bread elements). Such sous vide cooking can cook the meat or fish element 604 and frozen, uncooked dough elements 600, 602, and also soften the optional cheese 208. The U.S. Food and Drug Administration (FDA) recommends that the internal temperature of certain food products reach certain levels to be “safe.” For example, the FDA recommends that ground meat and meat mixtures of beef, pork, veal, and/or lamb should reach an internal temperature of 71° C. (160° F.) and that fresh beef, pork, veal, and lamb should reach an internal temperature of 63° C. (145° F.). Similarly, poultry should reach an internal temperature of 74° C. (165° F.).

Embodiments of the inventive method provide a controlled food preparation process that does not depend on the culinary skill of the final user. For example, the food item 212 can be re-heated by an unskilled user (e.g., a restaurant employee, or home user) who has minimal training. Thus, because the quality is controlled during the process, a consistent, high quality product can be delivered by employing embodiments of the inventive method.

Although only a few embodiments of the present invention have been shown and described, the present invention is not limited to the described embodiments. It will be appreciated by those skilled in the art that other changes may also be made to the disclosed embodiments without departing from the scope of the invention. In addition, any of the embodiments, features and/or elements disclosed herein may be combined with one another to form various additional combinations not specifically disclosed, as long as the embodiments, features and/or elements being combined do not contradict each other. All such changes and combinations are considered to be within the scope of the invention as defined by the appended claims and their equivalents.

What is claimed is:

1. A method of preparing a food item, comprising the steps of:
placing at least one uncooked protein element and at least one cooked bread element into a package without sealing the at least one cooked bread element to any other element in the package;
sealing the package without sealing the at least one cooked bread element to any other element in the package;
forming a food item by cooking the uncooked protein element in the sealed package without sealing the at least one cooked bread element to any other element in the package.

2. The method according to claim 1, wherein forming the food item by cooking the uncooked protein element in the sealed package without sealing the at least one cooked bread element to any other element in the package comprises cooking only the uncooked protein element.

3. The method according to claim 1, wherein the protein element comprises meat or fish.

4. The method according to claim 1, wherein the protein element comprises one of frozen egg and frozen egg white.

5. The method according to claim 4, wherein the one of frozen egg and frozen egg white further comprises cheese.

6. The method according to claim 1, wherein the at least one cooked bread element is fully cooked prior to placing the fully cooked bread element in the package.

7. The method according to claim 1, wherein the at least one cooked bread element is par-cooked prior to placing the par-cooked bread element in the package.

8. The method according to claim 1, wherein forming the food item comprises using sous vide cooking to cook the uncooked element or elements in the sealed package.

9. The method according to claim 1, wherein placing the uncooked protein element and the at least one cooked bread element into the package without sealing the at least one cooked bread element to any other element in the package comprises:
placing the protein element into the package between two cooked bread elements without sealing either of the two cooked bread elements to any other element in the package.

10. The method according to claim 1, further comprising placing cheese in the package prior to sealing the package.

11. The method according to claim 1, further comprising placing cooked onions in the package prior to sealing the package.

12. The method according to claim 1, further comprising placing a sauce or condiment in the package prior to sealing the package.

13. The method according to claim 1, further comprising placing seasoning in the package prior to sealing the package.

14. The method according to claim 1, further comprising placing a second protein element in the package prior to sealing the package.

15. The method according to claim 14, wherein the second protein element is fully cooked prior to placing the second protein element in the package.

16. The method according to claim 14, wherein the second kind of protein is cooked bacon.

17. The method according to claim 14, wherein the second protein element is uncooked prior to placing the second protein element in the package.

18. The method according to claim 1, wherein the protein element is ground meat.

19. The method according to claim 1, wherein the protein element is one of fish, sausage, beef, chicken, turkey, or pork.

20. A method of preparing a food item, comprising the steps:
placing uncooked ground meat and two cooked portions of a bun in a package, without sealing the two cooked portions of the bun to anything in the package;
vacuum sealing the package without sealing the two cooked portions of the bun to anything in the package;
forming a food item by cooking the ground meat in the sealed package without sealing the two cooked portions of the bun to anything in the package.

21. The method according to claim 20, wherein cooking the ground meat in the sealed package comprises cooking only the ground meat in the package.

22. The method according to claim 20, wherein cooking the ground meat in the sealed package comprises cooking the ground meat in the package and browning at least one of the two cooked portions of the bun.

23. The method according to claim 20, further comprising placing cooked bacon in the package prior to sealing the package.

24. The method according to claim 20, further comprising placing at least one of cheese, cooked onions, one or more sauces, and one or more condiments in the package prior to sealing the package.

25. A method of preparing a food item, comprising the steps of:
placing at least one uncooked protein element and at least one frozen, uncooked dough element into a package;
sealing the package;
forming a food item by cooking the uncooked protein element and the at least one frozen, uncooked dough element in the sealed package.

26. The method according to claim 25, wherein
placing the at least one uncooked protein element and the at least one frozen uncooked dough element into a package comprises placing the at least one uncooked protein element and the at least one frozen uncooked dough element into a package without sealing the at least one frozen uncooked dough element to any other element in the package;
sealing the package comprises sealing the package without sealing the at least one frozen uncooked dough element to any other element in the package; and
forming the food item by cooking the uncooked protein element and the at least one uncooked dough element in the sealed package comprises forming the food item by cooking the uncooked protein element and the at least one uncooked dough element in the sealed package to from a cooked protein element and at least one cooked bread element without sealing the at least one cooked bread element to any other element in the package.
